(19) United States
(12) Patent Application Publication
(10) Pub. No.: US 2023/0051144 A1
(43) Pub. Date: Feb. 16, 2023

(54) DEVICE AND METHOD FOR LISTEN-BEFORE-TALK RANDOM ACCESS WITH ADAPTIVE ENERGY DETECTION THRESHOLD SELECTION

(71) Applicant: JRD COMMUNICATION (SHENZHEN) LTD., Shenzhen, Guangdong (CN)

(72) Inventors: Tian Li, Shenzhen, Guangdong (CH); Jia Sheng, Shenzhen, Guangdong (CN)

(73) Assignee: JRD COMMUNICATION (SHENZHEN) LTD., Shenzhen, Guangdong (CN)

(21) Appl. No.: 17/760,091

(22) PCT Filed: Feb. 5, 2020
(86) PCT No.: PCT/CN2020/074364

§ 371 Date: Aug. 3, 2022

(51) Int. Cl. H04W 74/08; H04L 1/18

(52) U.S. Cl. CPC H04W 74/0808; H04L 1/1893; H04W 74/0833

(57) ABSTRACT

A method for listen-before-talk random access with adaptive energy detection threshold selection is executed by a device. Component units, such as code block groups (CBGs) in a transport block are determined to be retransmitted through a contention-based random access operation. A component unit based energy detection threshold (EDT) is selected. The EDT is associated with the component units determined to be retransmitted. The selected component unit based EDT is used to perform energy detection in an initial contention-based random access operation.

### BACKGROUND OF DISCLOSURE

### 1. Field of Disclosure

The present disclosure relates to the field of communication systems, and more particularly, to a device and a method for listen-before-talk random access with adaptive energy detection threshold selection.

### 2. Description of Related Art

Due to scarcity of licensed spectrum compared to increasing spectrum demands, stake-holders in cellular telecommunication business begin to use unlicensed bands for cooperation with licensed band networks.

### Technical Problem

When data is transmitted over an unlicensed band, transmission reliability and efficiency become an important issue. One main problem in unlicensed band communication is the unpredictable transmission opportunity in time in listen-before-talk (LBT) mechanism. A transmitter performing listen-before-talk (LBT) may suffer from data transmission backoff time before gaining access to an unlicensed channel. Furthermore, the more user equipment (UE) devices compete for access to unlicensed bands, the more likely is LBT failure. The unpredictable transmission opportunity may delay the data transmission which makes the communication in unlicensed spectrum much more challenging, especially for the low latency communication scenarios. The so-called hidden node problem and bursty interference create additional challenges.

A transmitter may need to perform energy detection to determine whether an unlicensed band has been occupied by another transmitter. Basically, energy detection is made by comparing the radio energy level in the targeting band against a pre-defined threshold. A transmitter may have to listen for a long time before accessing the unlicensed spectrum.

The disclosure proposes methods and devices to address the issue of transmission latency in unlicensed band.

### SUMMARY

An object of the present disclosure is to propose a device and a method for listen-before-talk random access with adaptive energy detection threshold selection.

In a first aspect of the present disclosure, a method for listen-before-talk random access with adaptive energy detection threshold selection is executed by a device. Component units, such as code block groups (CBGs) in a transport block are determined to be retransmitted through a contention-based random access operation. A component unit based energy detection threshold (EDT) is selected. The EDT is associated with the component units determined to be retransmitted. The selected component unit based EDT is used to perform energy detection in an initial contention-based random access operation.

In a second aspect of the present disclosure, a device includes a transceiver and a processor. The processor is connected with the transceiver and configured to execute the following steps comprising: determining component units in a transport block to be retransmitted through a contention-based random access operation; selecting a component unit based energy detection threshold (EDT) associated with the component units determined to be retransmitted; and using the selected component unit based EDT to perform energy detection in an initial contention-based random access operation.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product, that causes a computer to execute the disclosed method.

The disclosed method may be programmed as computer program, that causes a computer to execute the disclosed method.

### Advantageous Effects

Current LBT mechanism designed for TB level transmission involves an energy detection threshold (EDT) for TB level transmission. The threshold may be not reasonable especially when the transmitter only transmits a slight load, such as one code block group (CBG), in an unlicensed channel. The threshold may lead to continuous access attempts which may delay data transmission greatly. The disclosure provides a method for listen-before-talk random access with adaptive energy detection threshold selection to address existing latency issues in LBT mechanisms. The disclosed method may be applied to listen-before-talk (LBT) mechanisms in the New Radio based unlicensed (NR-U) spectrum.

For LBT initiated by a user equipment (UE) device, large load of the retransmitted TB may lead to LBT failure. According to the disclosed method, a series of CBG based EDTs are determined by adjusting the predefined EDT with an offset value, and used for energy detection to transmit a part of the TB. Several CBG based EDT may be selected to accommodate different scenarios. Flexibility and efficiency in the contention based unlicensed band access are thus improved. Additionally, a series of CBG based EDTs are proposed to be configured by RRC signaling and gNB’s control information. The disclosed methods improve LBT efficiency in NR-U.

For LBT initiated by a base station, after determining the CBGs to be retransmitted, the base station chooses a series of CBG based EDTs, which are higher than the predefined EDT. Alternatively, a series of CBG based EDTs are configured by RRC signaling. The base station determines and generates new CBGTI according to the CBGs, which are used to determine an EDT. The base station may use the determined EDT to perform a successful LBT. A UE detects and receives CBG according to the generated CBGTI.

### BRIEF DESCRIPTION OF DRAWINGS

In order to more clearly illustrate the embodiments of the present disclosure or related art, the following FIG.s will be described in the embodiments are briefly introduced. It is obvious that the drawings are merely some embodiments of the present disclosure, a person having ordinary skill in this field can obtain other FIG.s according to these figures.

FIG. 1 is a block diagram of a user equipment (UE) and a base station (BS) according to an embodiment of the present disclosure.

FIG. 2 is a schematic diagram showing embodiments of a disclosed method applied in uplink retransmission.

FIG. 3 is a schematic diagram showing a series of energy detection thresholds (EDTs).

FIG. 4 is a flowchart showing a method for listen-before-talk random access with adaptive energy detection threshold selection according to an embodiment of the present disclosure.

FIG. 5 is a flowchart showing a method for listen-before-talk random access with adaptive energy detection threshold selection according to another embodiment of the present disclosure.

FIG. 6 is a flowchart showing a method for listen-before-talk random access with adaptive energy detection threshold selection according to still another embodiment of the present disclosure.

FIG. 7 is a schematic diagram showing embodiments of the disclosed method applied in downlink retransmission.

FIG. 8 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

FIG. 1 illustrates that, in some embodiments, a user equipment (UE) 10 and a base station (BS) 20 for executing a method for listen-before-talk random access with adaptive energy detection threshold selection according to an embodiment of the present disclosure are provided. The UE 10 may include a processor 11, a memory 12, and a transceiver 13. Examples of the base station 20 may include an eNB or a gNB. The base station 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal through a wireless channel 110.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry and radio frequency (RF) circuitry to process radio frequency signals. When the embodiments of the invention are implemented in software, the techniques described herein can be implemented with modules, such as procedures, functions, and executable programs, that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via an interface.

The BS 20 may connect to a network entity device serving as a node in a CN. The CN may include LTE CN or 5GC which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

In some embodiments, a processor, such as the processor 11 or 21, is configured to execute a method for a method for listen-before-talk random access with adaptive energy detection threshold selection. Component units, such as code block groups (CBGs) in a transport block are determined to be retransmitted through a contention-based random access operation. A component unit based energy detection threshold (EDT) is selected. The EDT is associated with the component units determined to be retransmitted. The selected component unit based EDT is used to perform energy detection in an initial contention-based random access operation.

The disclosure provides two types of LBT mechanisms, including LBT initiated by a UE and LBT initiated by a BS. For LBT initiated by a UE, for example, the UE 10 selects an appropriate EDT with respects to CBG indication in the code block group transmission information (CBGTI) which is indicated by a BS, such as the BS 20, selects and retransmits CBGs. For LBT initiated by a BS, after determining the retransmitted CBGs, a BS, such as the BS 20, selects an optimal energy detection threshold and then generates CBGTI based on CBGs to be retransmitted.

An embodiment of the disclosed method involving LBT initiated by a UE and physical uplink shared channel (PUSCH) CBGTI determination are detailed in the following.

CBG based transmission has been adopted by 3GPP RANI in Rel-15, which includes CBG based physical downlink shared channel (PDSCH) transmission and CBG based physical uplink shared channel (PUSCH) transmission. If a UE is configured with CBG based transmission, the UE determines the number of CBGs for a transport block (TB).

For CBG based transmission, the CBGTI field in scheduling downlink control information (DCI) indicates which CBGs of a TB are present in new transmission or retransmission of the TB. The CBGTI field is of length N_{TB} ▪N bits, where N_{TB} is the number of TBs, and N is the number of CBGs in one TB. If N_{TB}=2, the CBGTI field bits are mapped such that the first set of N bits starting from the most significant bit (MSB) corresponds to the first TB while the second set of N bits corresponds to a second TB. The first M bits of each set of N bits in the CBGTI field for one TB have an in-order one-to-one mapping with the M CBGs in the TB, with the MSB mapped to CBG#0, that is, the first CBG in the TB.

For a retransmission of a TB as indicated by the new data indicator (NDI), CBGTI is used for indicating which CBGs of the TB are present in the retransmission. In detail, a bit value of ‘0’ in the CBGTI field that is mapped to a CBG indicates that the corresponding CBG is not transmitted in the retransmission. A bit value of ‘ 1’ mapped to a CBG indicates that CBG is transmitted in the retransmission.

When a BS transmits UL DCI 0_1 to schedule a single PUSCH, CBGTI field is present in the scheduling DCI. If a UE is configured to transmit CBG based transmissions, the UE determines the number of CBGs for a PUSCH transmission. After receiving uplink data in the PUSCH transmission, the BS generates respective hybrid automatic repeat request-acknowledgement (HARQ-ACK) information bits for the CBGs in a TB reception and then places the HARQ-ACK bits according to CBG ID. If the BS does not correctly detect the TB, the BS generates and transmits CBGTI in DCI 0_1 to the UE. Accordingly, the bit value of ‘1’ in the CBGTI associated with a CBG indicates that the associated CBG needs retransmission.

### CBG Based Energy Detection Threshold

CBG based energy detection thresholds (EDTs) are detailed in the following. A transmitter, such as the UE 10 or BS 20, selects a component unit based EDT associated with component units, such as CBGs, in a transport block determined to be retransmitted.

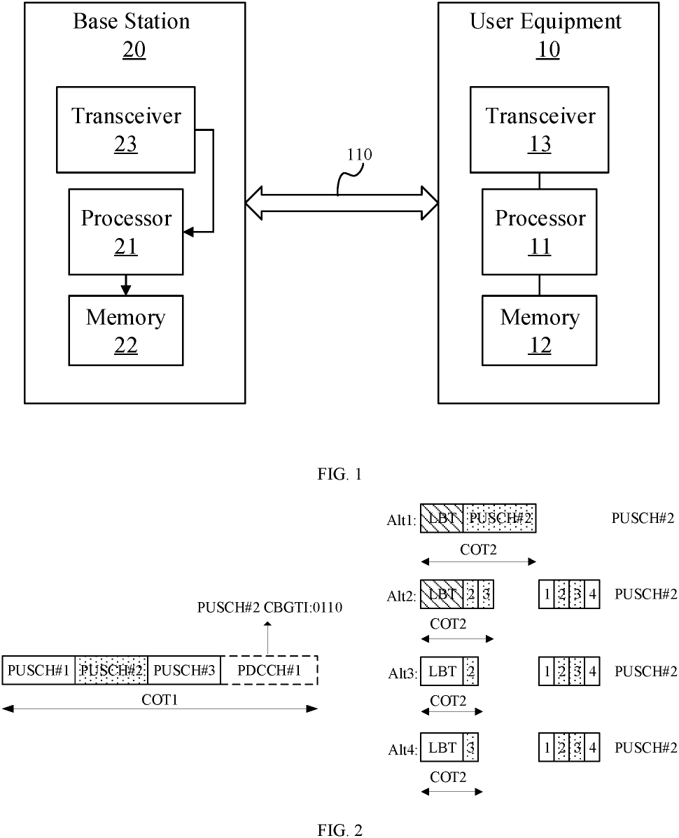

As is shown in FIG. 2, if the BS 20 transmit DCI to indicate that the UE 10 shall perform retransmission, the UE 10 performs LBT to access an unlicensed channel to retransmit data, such as PUSCH#2 in the FIG. 2. If the channel is occupied by other transmitters, such as another UE, and the BS 20 uses a pre-defined EDT directly for energy detection as usual, the UE 10 may likely encounter LBT failure due to the large load of the retransmitted TB, such as PUSCH#2 in FIG. 2. According to an embodiment of the disclosed method, the BS 20 may perform LBT using a CBG level EDT to capture the channel and retransmit the corresponding CBGs, such as second and third CBGs in the PUSCH#2.

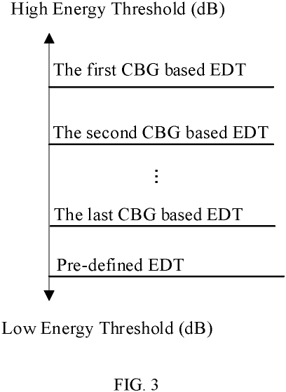

As shown in FIG. 3, a series of CBG based EDTs are proposed. A transmitter, such as the UE 10 or the BS 20, may select one of the CBG based EDTs to perform energy detection in LBT procedures. The first CBG based EDT corresponds to the EDT with N₁ CBG(s) for LBT procedures, where N₁=1,2,3...N and N is the maximum number of CBG in a TB. The second CBG based EDT corresponds to the EDT with N₂ CBGs for LBT procedures, where N₂ is an integer and N ≥N₂ ≥ N₁. Further, the last CBG based EDT corresponds to the EDT with N CBGs for LBT procedures.

For CBG based EDT determination, three implementation examples are proposed and any combinations of these three examples may contribute to a new implementation.

### Example 1 - UE Implementation

CBG based EDTs may be generated intrinsically by the UE 10. The UE 10 sets a series of actual EDTs to be greater than or equal to the predefined EDT which is pre-determined by configurations, such as higher layer parameters, BS output power, and/or allocated bandwidth. After the predefined EDT is determined, the actual EDT is set by adjusting the predefined EDT according to an offset value signaled by one or more higher layer parameters. The UE 10 obtains a series of CBG based EDTs to accommodate transmission of different data loads. Examples of the CBG based EDTs include the first CBG based EDT, the second CBG based EDT, ..., and the last CBG based EDT.

As is shown in FIG. 3, a pre-defined TB level EDT used for energy detection on an unlicensed channel occupied by another transmitter may easily lead to LBT failure at the UE 10. On the other hand, CBG level EDTs may facilitate the UE 10 to perform LBT successfully and then retransmit the corresponding CBGs.

### Example 2 - RRC Configuration

To simplify UE implementation, a series of CBG based EDTs, such as the first CBG based EDT, the second CBG based EDT, ..., and the last CBG based EDT, may be configured by radio resource control (RRC) signaling. The UE 10 may receive the RRC signaling and directly use these EDTs for energy detection carried in the RRC signaling without extra threshold calculation.

### Example 3 - BS Indication

The BS 20 determines a series of CBG based EDTs with respects to the configurations, such as high layer parameters, the BS output power, and/or employed bandwidth, and transmits the series of CBG based EDTs to the UE 10 through PDCCH or PDSCH. The series of CBG based EDTs includes the first CBG based EDT, the second CBG based EDT, ..., and the last CBG based EDT. The UE 10 may receive the control signals in the PDCCH or PDSCH and directly use these EDTs for energy detection carried in the PDCCH or PDSCH without extra threshold calculation. The control signals may include DCI or MAC control elements (MACCEs).

### CBG Selecting Methods

If failing to receive and decode a PUSCH transport block, such as the PUSCH#2, the BS 20 sets the corresponding CBGTI and then sends the CBGTI to the UE 10 through DCI. The UE 10 receives the DCI which indicates the UE 10 to retransmit M CBGs. The UE 10 may select one or more CBGs for retransmission. The goal of selecting CBG(s) is to retransmit as much CBGs as possible.

As is shown in the FIG. 2, several embodiments of CBG selecting are proposed to retransmit the CBGs as much as possible. Alt1-Alt4 represent embodiments 1 to 4 of data retransmission.

### Alternative 1

Serving as a current retransmission scheme, alternative embodiment 1 uses a pre-defined TB level EDT for energy detection in an LBT operation. When obtaining a transmission opportunity through a successful LBT operation, the UE 10 retransmits the whole TB, such as PUSCH#2 directly to the BS 20.

### Alternative 2

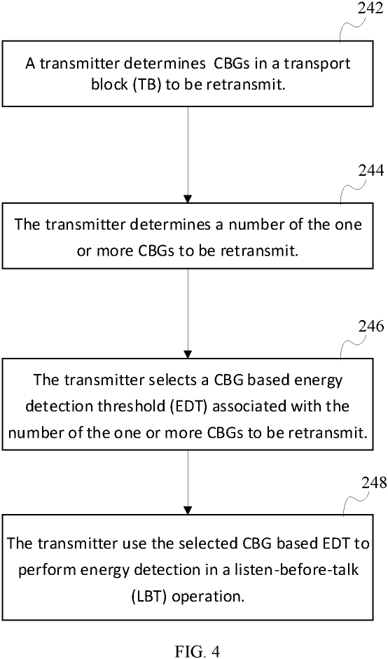

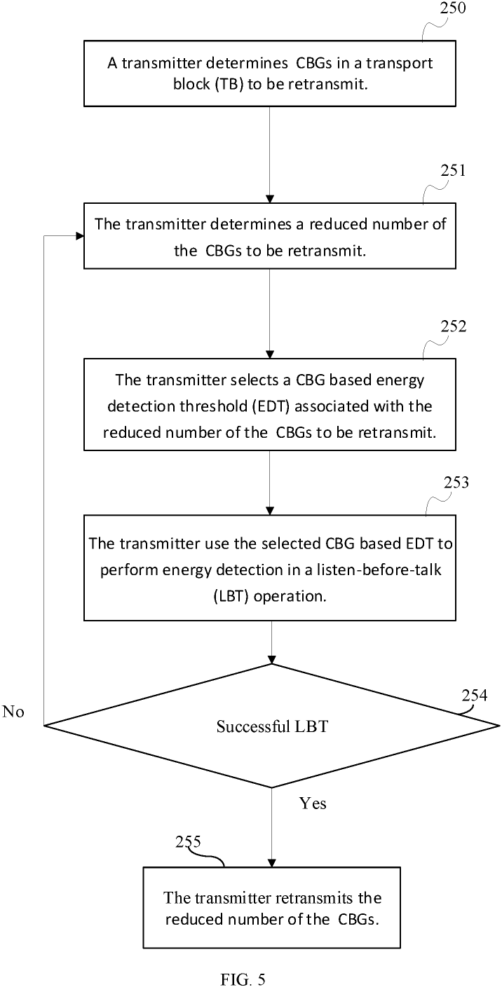

With reference to FIG. 4, a transmitter, such as the UE 10, determines one or more CBGs in a transport block (TB) to be retransmit (block 242). To transmit all the CBGs as soon as possible, the UE 10 transmits only M CBGs among the determined to-be-retransmitted CBGs to the BS, where M is the number of all the retransmitted CBGs, such as the CBG#2, CBG#3 in the PUSCH#2 as shown in FIG. 2.

The transmitter determines a number of the one or more CBGs to be retransmit (block 244), selects a CBG based energy detection threshold (EDT) associated with the number of the one or more CBGs to be retransmit (block 246), and uses the selected CBG based EDT to perform energy detection in a listen-before-talk (LBT) operation (block 248). The UE 10 uses a CBG based EDT, such as the second CBG based EDT, associated with a corresponding number of CBGs for energy detection in an LBT operation. In the example of FIG. 2, the UE 10 uses the second CBG based EDT associated with the two CBGs, that is CBG#2 and CBG#3, for energy detection in the LBT operation. Using a CBG based EDT may reduce latency greatly. When obtaining a transmission opportunity through a successful LBT operation, the UE 10 transmits all the M CBGs.

### Alternative 3

With reference to FIG. 5, a transmitter, such as the UE 10, determines one or more CBGs in a TB to be retransmit (block 250). The transmitter determines a reduced number of the one or more CBGs to be retransmit (block 251). The reduced number of the one or more CBGs forms a first subset of the CBGs in the TB.

If the LBT using the EDT proposed in alternative embodiment 2 is failed, another CBG based EDT with a smaller number may be used for energy detection in an LBT operation. If the LBT using the EDT proposed in alternative embodiment 2 is failed, the UE 10 selects a reduced number of CBGs starting from the first indicated CBG, such as CBG#2 in FIG. 2, for retransmission.

The transmitter selects a CBG based EDT associated with the reduced number of the one or more CBGs to be retransmit (block 252), and uses the selected CBG based EDT to perform energy detection in an LBT operation (block 253). Specifically, a CBG based EDT associated with (M-1) CBGs is used for energy detection in a first LBT attempt. The (M-1) CBGs forms a first subset of the CBGs in the TB. The UE 10 determines whether the LBT attempt is successful (block 254). If first LBT attempt is successful, the UE 10 retransmits the first (M-1) CBGs to the BS 20 (block 255). If first LBT attempt is failed, the number of CBGs is reduced by one to obtain (M-2) in a first reiteration of block 251. The UE 10 uses a CBG based EDT associated with (M-2) CBGs for energy detection in a second LBT attempt. The (M-2) CBGs forms a second subset of the CBGs in the TB. If the second LBT attempt is successful, the UE 10 retransmits the first (M-2) CBGs to the BS 20. If the second LBT attempt is failed, the UE 10 continues the similar procedure until the number of CBGs is reduced to one or LBT is successful. In alternative embodiment 3, the UE 10 retransmits the first several CBGs by default, and gradually reduces the number of CBGs for retransmission using a CBG based EDT associated with the number of CBGs to be retransmitted in LBT attempts. Since this rule is pre-defined by the BS 20 and the UE 10, the UE 10 need not to indicate the CBG IDs of the retransmitted CBGs to the BS 20. For example, as shown in FIG. 2, in a successful LBT with the first CBG based EDT, the UE 10 retransmits CBG#2 to the BS 20.

### Alternative 4

Similar to alternative embodiment 3, another CBG based EDT with a smaller number may be used for energy detection in an LBT operation. If the LBT using the EDT proposed in alternative embodiment 2 is failed, the UE 10 selects a reduced number of CBGs arbitrarily selected from the CBGs, such as CBG#2 and CBG#3 in FIG. 2, indicated for retransmission. Specifically, a CBG based EDT associated with the selected (M-1) CBGs is used for energy detection in a first LBT attempt. The (M-1) CBGs forms a first subset of the CBGs in the TB. If first LBT attempt is successful, the UE 10 retransmits the selected (M-1) CBGs to the BS 20. If first LBT attempt is failed, the number of CBGs is reduced by one to obtain (M-2). The UE 10 selects (M-2) CBGs from the CBGs indicated for retransmission and uses a CBG based EDT associated with (M-2) CBGs for energy detection in a second LBT attempt. The (M-2) CBGs forms a second subset of the CBGs in the TB. If the second LBT attempt is successful, the UE 10 retransmits the select (M-2) CBGs to the BS 20. If the second LBT attempt is failed, the UE 10 continues the similar procedure until the number of CBGs is reduced to one or LBT is successful. In alternative embodiment 4, the UE 10 retransmits the selected CBGs, and gradually reduces the number of selected CBGs for retransmission using a CBG based EDT associated with the number of selected CBGs to be retransmitted in LBT attempts. Since the selected CBGs is not preset by the BS 20 and the UE 10, the UE 10 may need to indicate the CBG IDs of the retransmitted CBGs to the BS 20.

The first subset of CBGs may be explicitly indicated by CBG transmission information (CBGTI) in downlink control information (DCI) for scheduling a physical uplink shared channel (PUSCH) which is accessible through a user equipment initiated listen before talk operation. Alternatively, the first subset of CBGs may be implicitly indicated between the BS and the UE.

In alternative embodiment 4, the UE 10 retransmits selected one or more CBGs at the cost of additional overhead of CBG ID related signaling. For example, as shown in FIG. 2, the UE 10 selects and transmits the CBG with the CBG ID of CBG#3.

Even if a small number of CBGs or only one CBG is retransmitted successfully, the UE 10 adds the CBG to a HARQ buffer of the corresponding TB, such as PUSCH#2 in the FIG. 2, which increase the possibility of successful detecting the TB.

An embodiment of the disclosed method involving LBT initiated by a gNB is detailed in the following. The BS 20 may determine one or more CBGs to be retransmitted.

The UE 10 capable of CBG based transmission and reception may receive a first PDSCH TB scheduled by DCI format 1_1, that includes CBGs of the TB. The UE 10 generates respective HARQ-ACK information bits for the CBGs of the TB and then places the HARQ-ACK bits according to CBG ID of the CBGs. If the UE 10 receives more subsequent PDSCH TBs, the UE 10 concatenates the HARQ-ACK information bits for CBGs of the subsequent PDSCH TBs after the first PDSCH TB. The UE 10 transmits HARQ-ACK bits to the BS 20, and the BS 20 may receive the HARQ-ACK bits and determine one or more CBGs to be retransmitted according to the HARQ-ACK bits.

### The BS 20 may use CBG Based Energy Detection Threshold

To retransmit the one or more CBGs, the BS 20 may use one of the CBG based EDT for energy detection in an LBT operation. If the HARQ-ACK codebook reported by the UE 10 indicates that the UE 10 detects at least one TB, such as PDSCH#2, unsuccessfully, the BS 20 performs an LBT to access to an unlicensed channel to transmit the at least one TB, such as PDSCH#2. To complete the retransmission as soon as possible, the BS 20 may use CBG based EDTs for LBT attempts. The BS 20 selects one of the CBG based EDTs so that the smaller CBG load the BS 20 transmits, the higher probability that the BS 20 accesses the channel through an LBT attempt. To reduce the load, the BS 20 divides the TB to be retransmitted into CBGs according to the CBG based HARQ-ACK codebook.

For CBG based EDT determination, two methods are proposed and any combinations of these two methods may contribute to a new method.

### Method1– EDT Provided by a BS

The BS 20 determines the predefined EDT preset with respects to configurations which includes high layer parameters, the BS 20 output power, and/or employed bandwidth. A series of CBG based EDTs higher than the predefined EDT are also proposed to selected by the BS 20 to support CBG based energy detection. The series of CBG based EDTs may include the first CBG based EDT, the second CBG based EDT, ..., and the last CBG based EDT. Specifically, the BS 20 may generate the CBG based EDTs.

### Method2– EDT Provided by RRC Configuration

To simplify BS implementation, a series of CBG based EDTs are proposed to be configured by RRC signaling. Specifically, the BS 20 may generate the CBG based EDTs according to RRC signaling.

### CBG Selection and CBGTI Determination are Detailed in the Following

Similar to the CBGs selection methods proposed in the description of UE initiated LBT, the BS 20 selects CBGs as much as possible in order to reduce the retransmission time. The BS 20 records CBGs to be retransmitted and generates the CBGTI bit field in DCI1_1 to indicate the CBGs to be retransmitted. Comparing to the existing CBGTI design, the BS 20 may select only a part of the CBGs to be retransmitted.

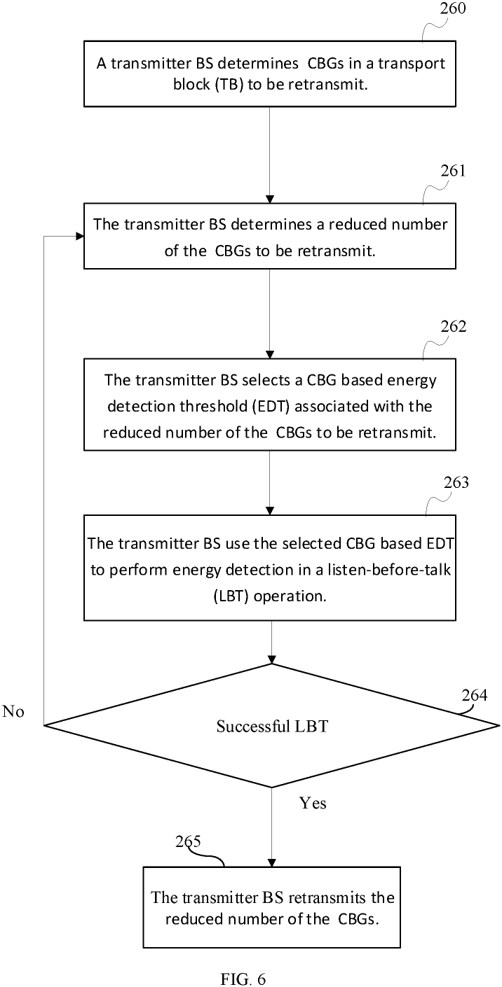

With reference to FIG. 6, a transmitter, such as the BS 20, determines one or more CBGs in a TB to be retransmit (block 260).The transmitter determines a reduced number of the one or more CBGs to be retransmit (block 261). For example, the BS 20 may select only (M-1) CBGs from M CBGs to be retransmitted and select a CBG based EDT associated with the (M-1) CBGs for energy detection.

The transmitter selects a CBG based EDT associated with the reduced number of the one or more CBGs to be retransmit (block 262), and uses the selected CBG based EDT to perform energy detection in an LBT operation (block 263). The BS 20 use the selected CBG based EDT for energy detection in an LBT attempt. Specifically, a CBG based EDT associated with the selected (M-1) CBGs is used for energy detection in a first LBT attempt. The (M-1) CBGs forms a first subset of the CBGs in the TB. The BS 20 determines whether the LBT attempt is successful (block 264). If first LBT attempt is successful, the BS 20 retransmits the selected (M-1) CBGs to the UE 10 (block 265). If first LBT attempt is failed, the number of CBGs is reduced by one to obtain (M-2) in a first reiteration of block 261. The BS 20 selects (M-2) CBGs from the CBGs indicated for retransmission and uses a CBG based EDT associated with (M-2) CBGs for energy detection in a second LBT attempt. The (M-2) CBGs forms a second subset of the CBGs in the TB. If the second LBT attempt is successful, the BS 20 retransmits the select (M-2) CBGs to the UE 10. If the second LBT attempt is failed, the BS 20 continues the similar procedure until the number of CBGs is reduced to one or LBT is successful.

If the UE 10 successfully detects the CBGs according to CBGTI, the UE 10 adds these CBGs into a corresponding TB HARQ buffer and receives other retransmitted CBGs until retransmission of the CBG is completed.

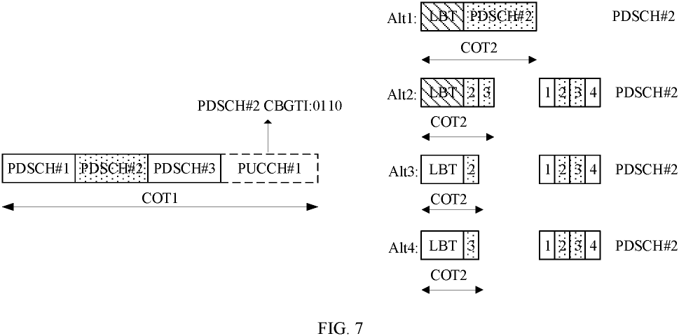

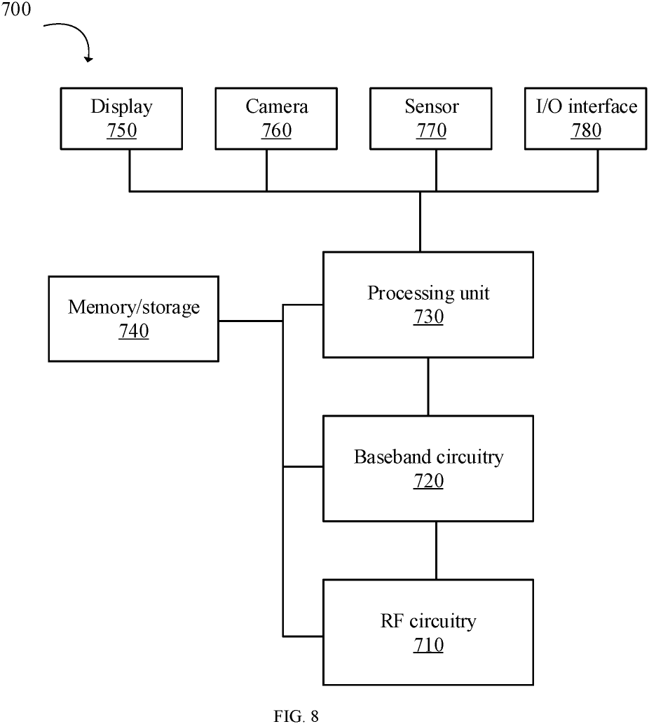

As is shown in FIG. 7, if LBT is successful when alternative embodiment 3 is used rather than alternative embodiment 2, the CBGTI value is ‘0100’ instead of ‘0110’, thus to indicate the BS 20 to retransmit CBG#2 out of CBG#2 and CBG#3. After successfully detects the CBG#2, the UE 10 puts CBG#2 into PDSCH#2 buffer to facilitate successful detection of this TB PDSCH#2.

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The disclosed method provides flexible QoS management based on sidelink traffic types. Sidelink transmission of each traffic type may have configurable priority to meet different communication cases and QoS requirements according to the disclosure.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for listen-before-talk random access with adaptive energy detection threshold selection, executable by a device, comprising:
determining component units in a transport block to be retransmitted through a contention-based random access operation;
selecting a component unit based energy detection threshold (EDT) associated with the component units determined to be retransmitted; and
using the selected component unit based EDT to perform energy detection in an initial contention-based random access operation.

2. The method of claim 1, wherein the contention-based random access operation is a listen-before-talk operation.

3. The method of claim 2, wherein the listen-before-talk operation is used to access a new radio unlicensed band.

4. The method of claim 2, wherein each of the component units in a transport block comprises a code block group (CBG) in the transport block, and component unit based EDT comprises a CBG-based EDT.

5. The method of claim 4, further comprising:
determining a first subset of CBGs in the transport block to be retransmitted, wherein the first subset has a reduced number of CBGs that is less than a total number of to-be-retransmitted CBGs in the transport block; and
selecting a first CBG based EDT associated with the reduced number of the CBGs in the first subset to be retransmitted; and
using the selected first CBG based EDT to perform energy detection in a first subsequent contention-based random access operation.

6. The method of claim 5, further comprising:
determining a second subset of CBGs in the transport block to be retransmitted, wherein the second subset has a reduced number of CBGs that is less than a total number of the to-be-retransmitted CBGs in the first subset; and
selecting a second CBG based EDT associated with the reduced number of the CBGs in the second subset to be retransmitted; and
using the selected second CBG based EDT to perform energy detection in a first subsequent contention-based random access operation.

7. The method of claim 5, wherein the first subset of CBGs is explicitly indicated by CBG transmission information (CBGTI) in downlink control information (DCI) for scheduling a physical uplink shared channel (PUSCH) which is accessible through a user equipment initiated listen before talk operation.

8. The method of claim 5, wherein the first subset of CBGs is implicitly configured between a user equipment (UE) and a base station.

9. The method of claim 8, wherein the first subset of CBGs ranging from a first to-be-retransmitted CBG in the transport block.

10. The method of claim 5, wherein the first CBG based EDT associated with the reduced number of the CBGs in the first subset is selected from a plurality of CBG based EDTs of which a higher CBG based EDT is associated with a less data load of CBGs for retransmission, and a lower CBG based EDT is associated with a greater data load of CBGs for retransmission.

11. The method of claim 10, wherein the plurality of CBG based EDTs are generated intrinsically by the device.

12. The method of claim 10, wherein the plurality of CBG based EDTs are provided by radio resource control (RRC) signaling.

13. The method of claim 10, wherein the plurality of CBG based EDTs are provided by control signaling in a physical downlink control channel (PDCCH).

14. The method of claim 10, wherein the plurality of CBG based EDTs are provided by control signaling in a physical downlink shared channel (PDSCH).

15. A device, comprising:
a transceiver; and
a processor connected with the transceiver and configured to execute the following steps comprising:
determining component units in a transport block to be retransmitted through a contention-based random access operation;
selecting a component unit based energy detection threshold (EDT) associated with the component units determined to be retransmitted; and
using the selected component unit based EDT to perform energy detection in an initial contention-based random access operation.

16. The method of claim 15, wherein the contention-based random access operation is a listen-before-talk operation.

17. The device of claim 16, wherein the listen-before-talk operation is used to access a new radio unlicensed band.

18. The device of claim 16, wherein each of the component units in a transport block comprises a code block group (CBG) in the transport block, and component unit based EDT comprises a CBG-based EDT.

19. The device of claim 18, wherein the processor is further configured to execute:
determining a first subset of CBGs in the transport block to be retransmitted, wherein the first subset has a reduced number of CBGs that is less than a total number of to-be-retransmitted CBGs in the transport block; and
selecting a first CBG based EDT associated with the reduced number of the CBGs in the first subset to be retransmitted; and
using the selected first CBG based EDT to perform energy detection in a first subsequent contention-based random access operation.

20-28. (canceled)

29. A chip, comprising:
a processor, configured to call and run a computer program stored in a memory, to cause a device in which the chip is installed to execute the method of claim 1.

30-32. (canceled)
